(19) United States
(12) Patent Application Publication
(10) Pub. No.: US 2016/0368086 A1
(43) Pub. Date: Dec. 22, 2016

(54) METHODS AND APPARATUS FOR PROCESSING TRANSPARENT MATERIALS

(71) Applicants: ELECTRO SCIENTIFIC INDUSTRIES, INC., Portland, OR (US); Association Alphanov, Centre Technologique Optique et Laser, Talence (FR)

(72) Inventors: Geoffrey Lott, Portland, OR (US); Nicolas Falletto, Beaverton, OR (US); Rainer Kling, Cestas (FR)

(21) Appl. No.: 15/180,709

(22) Filed: Jun. 13, 2016

Related U.S. Application Data
(60) Provisional application No. 62/180,568, filed on Jun. 16, 2015.

(51) Int. Cl. B23K 26/0622; B23K 26/08; B23K 26/402; C03B 33/08; B23K 26/382

(52) U.S. Cl. CPC B23K 26/0624; C03B 33/082; B23K 26/382; B23K 26/402; B23K 26/08; B23K 2203/54

(57) ABSTRACT

A method for forming features in a substrate includes irradiating a substrate with a beam of laser pulses, wherein the laser pulses have a wavelength selected such that the beam of laser pulses is transmitted into an interior of the substrate through a first surface of the substrate. The beam of laser pulses is focused to form a beam waist at or near a second surface of the substrate, wherein the second surface is spaced apart from the first surface along a z-axis direction, and the beam waist is translated in a spiral pattern extending from the second surface of the substrate toward the first surface of the substrate. The beam of laser pulses is characterized by a pulse repetition rate in a range from 20 kHz to 3 MHz, a pulse duration, a pulse overlap, and a z-axis translation speed.

### CROSS-REFERENCE TO RELATED APPLICATIONS

This application claims the benefit of U.S. Provisional Application No. 62/180,568, filed Jun. 16, 2015, which is incorporated by reference in its entirety.

### TECHNICAL FIELD

Embodiments of the present invention relate generally to laser processing transparent materials such as sapphire and glass.

### BACKGROUND

The outstanding scratch resistance, corrosion resistance, biocompatibility, and thermal stability offered by sapphire makes it an attractive material for numerous current and next-generation technologies. With a Mohs index of 9, sapphire is one of the hardest known materials. The scratch resistance imparted by this hardness, along with good optical transparency from the visible through mid-IR spectrum, has led to the broad utilization of sapphire as cover glasses in consumer electronics and luxury watches, and as windows for military and civilian vehicles.

Sapphire is a prime material for many medical implants and devices because it demonstrates superior biocompatibility and inertness in comparison to metals and polymers. The thermal stability of sapphire is one of the reasons that it is the predominant choice as a substrate for light-emitting diode, along with its strength and electrical insulation capacity. The high corrosion and thermal resistance of sapphire has found use in many harsh chemical and thermal environments.

As a consequence of its widespread use, worldwide sapphire production has steadily increased in recent years. However, the growth of sapphire use in some markets, including consumer electronics, has lagged behind forecasts. Part of the reason for this is that the same hardness that is beneficial for many applications also makes sapphire a very difficult material in which to machine fine structures via conventional and laser processing methods.

### BRIEF DESCRIPTION OF THE DRAWINGS

FIG. 1 schematically illustrates a bottom-up ablation geometry and spiral pattern cross-section according to one embodiment of the present invention.

FIG. 2 illustrates some examples of top and bottom for holes formed according to example embodiments disclosed herein.

FIG. 3 illustrates graphs of Average taper vs. z-axis translation speed for 400 μm diameter holes drilled with repetition rates of 104 kHz (top left), 260 kHz (top right), 521 kHz (bottom left), and 1042 kHz (bottom right). Separate lines are shown for each individual overlap condition.

FIG. 4 schematically illustrates conditions suitable for drilling holes (a) entirely with bottom-up ablation, and (b) hybrid bottom-up/top-down ablation.

FIG. 5 schematically illustrates profilometry measurements.

FIG. 6 illustrates laser scanning microscopy images of top surface of 400 μm diameter holes drilled with repetition rates of 104 kHz (top row), 260 kHz (second row), 521 kHz (third row) and 1042 kHz (bottom row). Pictures shown are representative of the evolution of hole quality as a function of z-axis/processing speed. Red arrows on 104 kHz pictures are placed to guide the eye to cracks/damage.

FIG. 7 illustrates a plot of hole quality vs. taper angle for all holes drilled at repetition rates of 104 kHz, 260 kHz, 521 kHz, and 1042 kHz. Holes are attributed a value of “1” if they do not have cracks or significant chips, and a value of “0” if there is significant chipping or any cracking.

FIG. 8 illustrates the evolution of back-side damage rings from minor, barely visible effects (left) to very prominent damage that also results in decreased back-side hole quality (right).

### SUMMARY

One embodiment of the present invention can be characterized as a method for forming a feature in a substrate includes irradiating a substrate with a beam of laser pulses, wherein the laser pulses have a wavelength selected such that the beam of laser pulses is transmitted into an interior of the substrate through a first surface of the substrate. The beam of laser pulses is focused to form a beam waist at or near a second surface of the substrate, wherein the second surface is spaced apart from the first surface along a z-axis direction, and the beam waist is translated in a spiral pattern extending from the second surface of the substrate toward the first surface of the substrate. The beam of laser pulses is characterized by a pulse repetition rate in a range from 20 kHz to 3 MHz, a pulse duration, a pulse overlap, and a z-axis translation speed.

Another embodiment of the present invention can be characterized as an apparatus that includes a laser source configured to generate a beam of laser pulses, a beam steering system configured to scan the beam of laser pulses along X- and Y-axis directions, a z-axis translation system configured to translate a beam waist generated upon focusing the beam of laser pulses along a Z-axis direction and a controller coupled to at least one of the laser source, the beam steering system and the z-axis translation system. The controller is operative to control at least one of the laser source, the beam steering system and the z-axis translation system to perform the method described in the paragraph above. Yet another embodiment of the present invention can be characterized as an article including a substrate having a hole formed according to the method described in the paragraph above.

### DETAILED DESCRIPTION

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be disproportionate and/or exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

In view of the trends in sapphire usage noted above, the inventors have performed laser ablation studies of sapphire using ultrashort pulsed lasers in diverse processing conditions, suitable for drilling holes in 430 μm thick sapphire wafers (although the techniques disclosed herein may also be applied to drill holes or form other features in sapphire wafers thicker than, or thinner than 430 μm). Although studies involving the drilling of holes <500 μm in diameter were performed with a 0.8 ps, 1030 nm laser source, it will be appreciated that the benefits of the techniques disclosed herein can be realized with pulse durations of 50 ps or less (e.g., 40 ps or less, 30 ps or less, 20 ps or less, 10 ps or less, 5 ps or less, 2 ps or less, 1 ps or less, 0.8 ps or less, etc.), provided that other processing parameters are adjusted accordingly. Likewise, the laser source can generate laser energy at wavelengths other than 1030 nm (e.g., at 1064 nm, 532 nm, 515 nm, 355 nm, 343 nm, or the like or any wavelength therebetween, or greater than 1064 nm, or less than 343 nm). Similarly, although the studies described herein involved the formation of holes in sapphire, it will be appreciated that the techniques discussed herein may be applied to form holes in other transparent materials such as glass (e.g., fused quartz, soda-lime glass, sodium borosilicate glass, alkaline earth aluminosilicate glass, alkali aluminosilicate glass, oxide glass, or the like or any combination thereof), provided that the processes parameters discussed herein are selected accordingly. Although the studies described below were restricted to a maximum pulse energy of 26.4 μJ and therefore a peak fluence of 20.7 J/cm² for a 1/e² beam waist of 18 μm, it will be appreciated that the benefits of the techniques disclosed herein can be realized with 1/e² spot sizes smaller than 18 μm (or larger than 18 μm), provided that the maximum pulse energy is selected or otherwise adjusted to maintain a peak fluence sufficiently high to initiate or sustain an ablation process. The aim of this work was to define the parameter space for drilling holes in a transparent material in terms of repetition rate, pulse overlap, and beam waist height. As used herein, the term “pulse overlap” refers to the spatial overlap of consecutively-delivered laser pulses at the beam waist of each of the pulses. The goal is provide holes (e.g., through holes, blind holes, etc.) with diameters in a range from 50 μm to 5 mm, that are free of chips, cracks, or other damage with average taper angles of <5° and drilling speeds of as low as ˜4 seconds per hole. Holes with taper lower than 2° were achieved.

### Experimental

These studies were performed with a 0.8 picosecond 1030 nm laser, verified with autocorrelation and a spectrum analyser, with a maximum on-sample pulse energy of 26.4 μJ and repetition rate of up to 3 MHz. The experimental apparatus uses, as a beam steering system, a scanning galvanometer (20 mm entrance aperture) and 100 mm telecentric focusing lens. A 4× beam expander increases the 99% beam diameter from 4.6 mm to 18 mm, generating a measured beam waist of 18 μm at 1/e² on sample for a maximum peak fluence of 20.7 J/cm². Polarization of the laser beam is linear out of the laser, and is changed to circular polarization by use by use of a λ/4 waveplate.

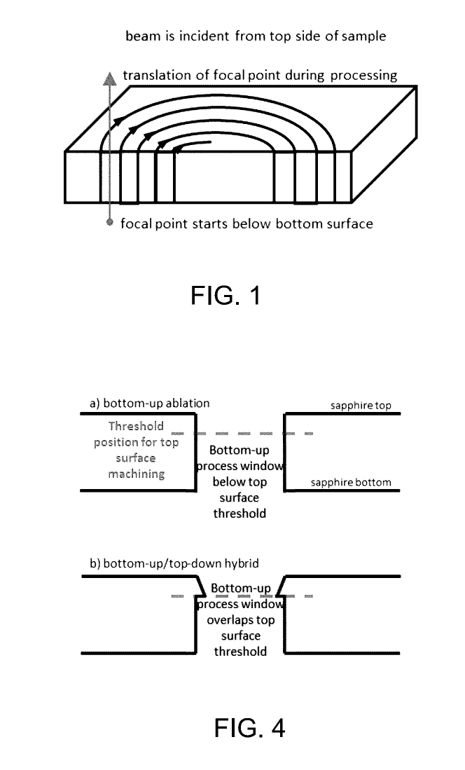

The pattern for all drilling processes presented herein is a spiral with an added circular revolution at the full spiral diameter for each spiral repetition (inward+outward return path) to optimize quality of the feature edges. A rough sketch of the pattern cross-section is depicted in FIG. 1. Processing parameters including scanning speed/pulse overlap, laser repetition rate, pulse energy, and pattern diameter were varied throughout these studies in order to determine the optimum processing conditions for sapphire drilling with 0.8 ps pulses. Pitch is held constant at 9 μm (half the beam waist) for all tests. All tests are conducted with the maximum pulse energy on sample of 26.4 μJ. Experiments were performed in ambient air without any gas shielding.

430 μm thick, 50.8 mm diameter dual-polished c-plane sapphire wafers were used throughout these studies. The effective thickness for machining these wafers—the distance that the beam waist must be translated along the z-axis to move from the top surface of the wafer to the bottom surface (or vice versa)—is ˜250 μm, equal to the 430 μm thickness of the sapphire wafer divided by its index of refraction (n=1.75). Z-axis translation of the beam waist may be accomplished by translating the scan lens along the Z-axis, by translating a stage (e.g., along the Z-axis) on which the sapphire sample is supported, by chirping an acousto-optic deflector system, or the like or any combination thereof.

Through holes were drilled by using an ablative process in a bottom-up geometry, as shown in FIG. 1. The bottom-up ablation method has been utilized to generate zero-taper holes in a wide variety of glasses in previous works. In this configuration, the laser beam begins with its beam waist below the bottom surface of the sapphire wafer. When processing begins, the beam waist is translated upwards (i.e., through the sample) at a constant velocity along the z-axis, with speeds typically between 10 μm/s and 50 μm/s or higher. Movement along the z-axis ceases when the beam waist reaches the top surface of the sapphire sample. Throughout the drilling process, plasma is visible to the eye. When drilling is complete, the spiral pattern ceases to be visible, and sample processing is immediately stopped manually.

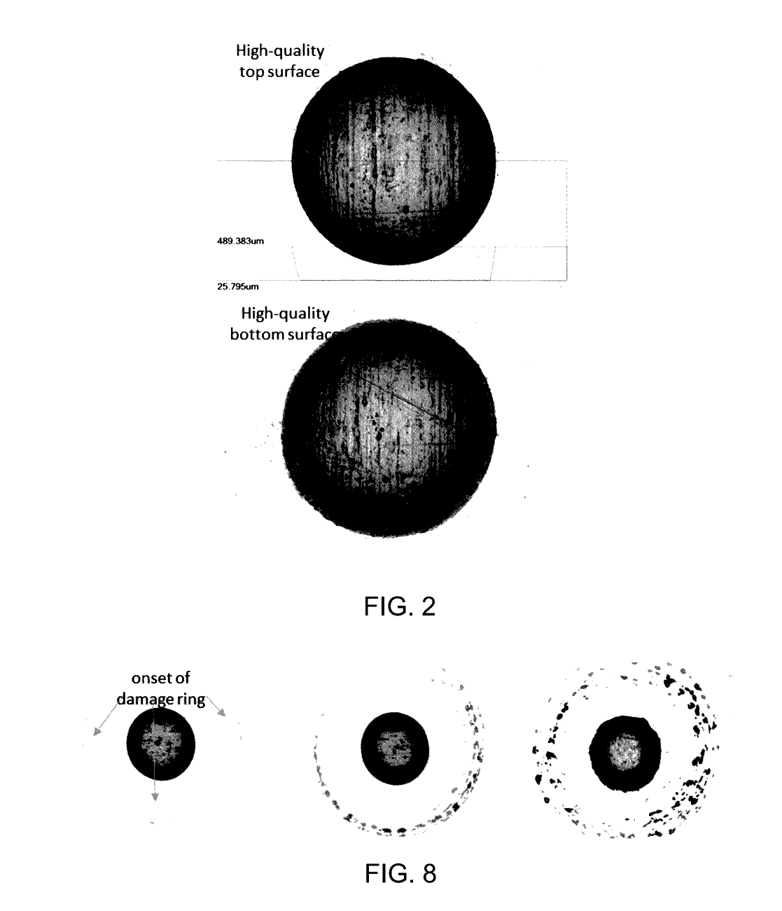

In FIG. 2, examples of the highest quality holes that generated in these tests are illustrated. In FIG. 2, the textured area in the middle of the holes is from the sample stage of the laser microscope, and is not indicative of anything regarding the quality of the holes drilled in sapphire. The top and bottom surface images (top and bottom panels, respectively) demonstrate very low taper (<2°), no chipping, and no cracking. The bottom surface reveals a nearly identical diameter as the top, and also reveals no chipping or cracking.

We observe the hole diameter on top and bottom surfaces to be nearly identical, but we do not observe the generation of zero-taper holes in any experimental conditions. The reason for this is the redeposition of molten sapphire particulates along the hole sidewall during processing. This is visible in both the high-quality and poor-quality results in FIG. 2—in both cases, dense aggregates of molten sapphire particulates are observed inside the hole on the bottom side of the sapphire wafer (i.e. the side that the ablated material must be ejected from during bottom-up processing). In this paper we will determine the parameters that yield the lowest taper, and therefore the least amount of redeposited material along the hole sidewall. Processed samples were cleaned with an alcohol swab to remove debris and particulates from the wafer surface, but this did not affect redeposited material in the hole. Future studies will examine techniques for reducing this redeposition during processing, and for removing the redeposited material with post-processing.

The profiles of holes generated with these processes were analyzed with a laser scanning microscope (Keyence VK-9700, VK9710) to determine quantitative parameters such as maximum (i.e. hole entrance) and minimum hole diameter and average taper angle, as well as qualitative characteristics including cracking and chipping. Images are generated with 2 μm step size across the entire thickness of the sapphire wafer. Each hole was analyzed across two orthogonal lines, and the results for hole entrance diameter and internal hole diameter were averaged for these two lines. These results were used to determine the hole taper angle. The average taper angle, θ, of each hole is determined from the hole diameter on the top surface (T), the minimum internal hole diameter (B), and the sample thickness (h):

$$θ = {tan}^{- 1} ( \frac{T - B}{2 h} ) \qquad ( 1 )$$

### Results and Discussion

Drilling holes that have a relatively small diameter and are high in aspect ratio (sample thickness:hole diameter) often results in an extremely restricted parameter space for generating high quality holes, from which little useful general information can be learned. On the other hand, drilling holes that have a relatively large diameter and low aspect ratio result in a very broad effective parameter space that also results in little general information. The bulk of the trials performed throughout these studies were done with a pattern diameter of 400 μm diameter (aspect ratio of ˜1), which is expected to be a suitable mid-point between these limiting cases. Therefore, lessons learned from these studies are useful as guidelines for helping to determine optimum laser machining parameters for holes from very small (down to 100 μm diameter or smaller) to very large (multiple millimeters) dimensions.

We drilled 400 μm diameter holes with pulse repetition rates of 21 kHz, 104 kHz, 260 kHz, 521 kHz, and 1042 kHz. At each repetition rate, holes were drilled with pulse overlaps (at the beam waist) of 70%, 80%, 90%, 95%, and 98% of the beam diameter if possible. As repetition rate is increased, the scanning speed required for any particular pulse overlap must also increase. While the straight line speed of the galvanometer is reliable at speeds of >10 m/s, it is important to note that processing speeds for features of 400 μm size are restricted to much lower values. We observed that the movement speed was limited to a maximum of <800 mm/s for the 400 μm diameter spiral pattern. Due to this limitation, we were unable to perform studies on all pulse overlap conditions at all repetition rates.

At each pulse overlap, the translation of the focus along the z-axis was varied from 10 μm/s to ≧50 μm/s, unless significant and regular damage was observed at lower processing speeds. We limit the slowest z-axis translation speed to 10 μm/s to ensure that hole throughput remains reasonable. We will present no results for tests performed at 21 kHz—holes drilled at 21 kHz were occasionally of acceptable quality, but the results were not consistent, and most often resulted in severe cracking and damage to the sapphire substrate across all repetition rates and pulse overlaps.

### Minimizing Taper

Taper values calculated using Equation 1 for this array of repetition rates, pulse overlaps, and z-axis speeds are shown in FIG. 3. Error bars are determined from differences in taper calculated from the two orthogonal hole profiles, as described above.

Turning to the results generated at a repetition rate of 260 kHz with 90% pulse overlap (top right chart in FIG. 3, data indicated by the ▴'s). As a function of z-axis translation speed, it appears that the evolution of the taper can be separated into two distinct regions—an approximately linear regime at high speed (≧60 μm/s) and a more complex regime at speeds <60 μm/s. In this lower speed range, we see an increase in taper as the z-axis translation speed is increased from 10 μm/s to 40 μm/s, and then a slight decrease in taper as the speed is increased from 40 μm/s to 60 μm/s. For this data set, the value of 40 μm/s corresponds to the highest z-axis translation speed that, observed by eye, drilled a hole with only bottom-up ablation and not a hybrid bottom-up/top-down process. At low z-axis translation speeds (e.g., ≦40 μm/s in this data set), we observe that the bottom-up process begins with the beam waist far below the bottom surface of the wafer due to heat accumulation and incubation effects. These effects are maintained throughout the entire process, and drilling is completed after ˜250 μm of z-axis translation, before accumulation/incubation effects exceed threshold and initiate ablation on the top surface, as is shown in FIG. 4a. However, as the z-axis speed is increased above 40 μm/s, we observe the onset of bottom-up ablation to occur with the beam waist closer and closer to the bottom surface of the sapphire wafer. Consequently, the z-axis value for the end of the 250 μm bottom-up processing window also shifts to a higher value. Eventually, the bottom-up processing window overlaps the z-axis position that initiates ablation on the top surface of the sapphire wafer. Thus, at z-axis speeds of 40 μm/s and higher, the process becomes a hybrid bottom-up/top-down process, as shown in FIG. 4b, where the ratio of top-down processing to bottom-up processing increases with increasing z-axis speed.

At slower z-axis speeds resulting in this hybrid process, the bottom-up portion of the process proceeds deep into the wafer before switching to the top-down portion of the process. The decrease in taper from 40 μm/s to 60 μm/s can be understood as follows: since the bottom-up process does not proceed all the way through the wafer, a thinned layer of molten sapphire is redeposited along the sidewall. The top-down process creates a tapered wall that does not extend past the thickness of this redeposited layer, resulting in a lower taper than the bottom-up holes generated at the highest speeds before this transition. As the speed is increased beyond 60 μm/s, the switch from bottom-up to top-down occurs earlier, resulting in wall taper that does extend past the redeposition layer, resulting in a ledge or overhang that decreases the minimum diameter of the hole and therefore leading to the general trend of increasing taper from 60 μm/s to 200 μm/s.

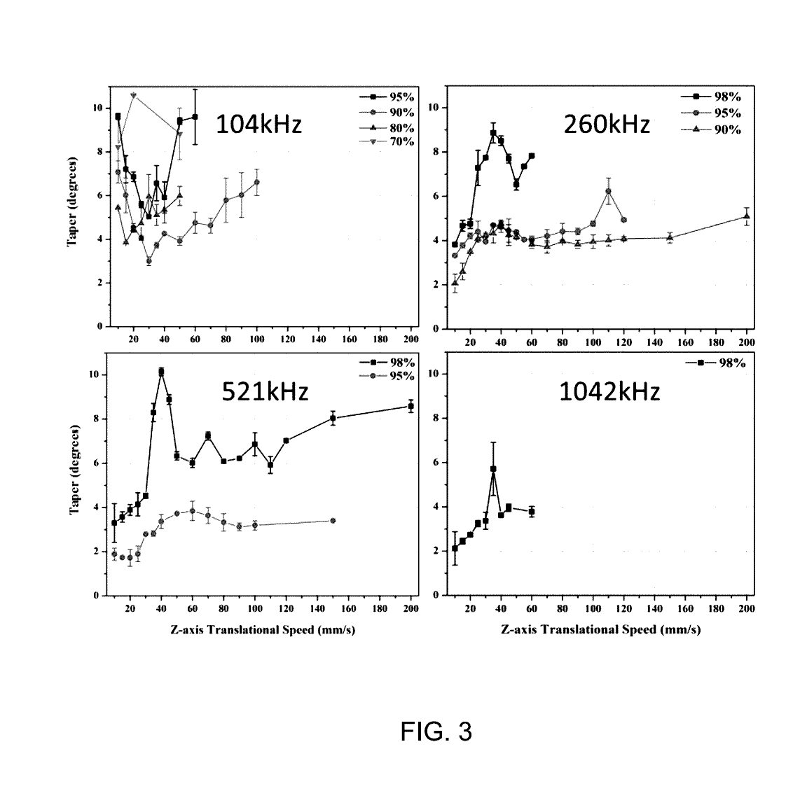

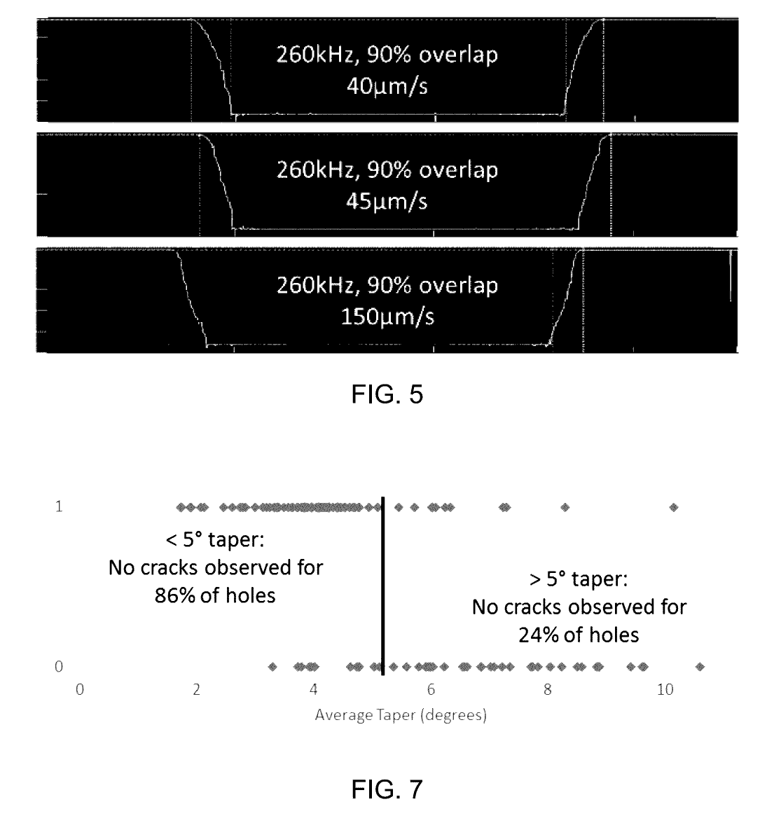

This transition from a solely bottom-up process to a hybrid process is also confirmed by the curvature of the hole wall as determined by profilometry measurements. The bottom-up process generates walls that are slightly convex towards the top surface of the sapphire wafer, while hybrid holes that are completed with the top-down process are concave, as is characteristic in general of a top-down process. This can be observed in FIG. 5—the difference in sidewall curvature from 40 μm/s to 45 μm/s in this data set at 260 kHz and 90% pulse overlap is subtle, but visible. The effect becomes more pronounced as the z-axis translation speed is further increased, as shown in the bottom panel of FIG. 5 for 150 μm/s.

As the pulse overlap is increased to 95% at 260 kHz (top right chart in FIG. 3, data indicated by the 's), the observations and trends that we have characterized for 90% pulse overlap at 260 kHz are in excellent agreement, albeit with slightly higher average taper values at 95% than at 90%. Similarly, these observations can be extended to pulse overlap of 98% (top right chart in FIG. 3, data indicated by the ▪'s), though the holes begin to exhibit serious, large cracks at 30 μm/s and higher, so the data set was truncated at 60 μm/s. The pattern speeds required for pulse overlaps of 80% and 70% at 260 kHz were too high for the galvanometer, but may be achieved using another beam steering system such as one or more acousto-optic deflectors, fast steering mirrors, or the like or any combination thereof.

We have observed that the average taper angle for holes drilled at 260 kHz increases as pulse overlap is increased, and as the z-axis translation speed is increased. Both of these trends correspond to increased taper when the spatial periodicity of the spiral pattern along the z-axis is increased when the spiral pattern speed is decreased (i.e. pulse overlap is increased), the distance between successive patterns repetitions along the z-axis is also increased, which is also true when the process speed along the z-axis is directly increased. It is possible that this may also contribute to the observed increases in average taper angle, but cross-sections of drilled holes as a function of these variables has not yet been examined to confirm or refute this possibility.

These trends as a function of z-axis translation speed at 260 kHz also apply to results obtained from drilling at a repetition rate of 521 kHz (lower left chart in FIG. 3) and at a repetition rate of 1042 kHz (lower right chart in FIG. 3), though there are fewer accessible pulse overlap conditions at higher repetition rates, and the 98% pulse overlap data set at 1042 kHz was not continued past 60 μm/s due to considerable cracking and surface damage. At higher repetition rates, incubation effects are increased, shifting the beginning of the bottom-up processing window below that of a lower repetition rate at the same pulse overlap and z-axis translation speed. This results in onset of the hybrid process at a higher z-axis translation speed at higher repetition rate. This is clearly visible at 95% pulse overlap for 521 kHz, where the transition was observed by eye to occur at 50 μm/s instead of 40 μm/s as for 260 kHz. It is difficult to confirm this behavior for 98% pulse overlap at 521 kHz and 1042 kHz due to larger fluctuations in taper and significant damage to most holes drilled in these conditions. Series of holes drilled at a repetition rate of 104 kHz (upper left chart in FIG. 3) deviate strongly from trends at higher repetition rates for all pulse overlaps studied. These holes were of relatively poor quality and a very high likelihood of cracking.

One consequence of this hybrid process to consider is the effect that it has on throughput. When the process is comprised solely of bottom-up ablation, the drilling time for a single hole is equal to the effective sample thickness of 250 μm divided by the z-axis translation speed. The hole taper is generally minimized at the slowest z-axis translation speeds, with the obvious drawback of low throughput in these conditions. For speeds of 40-50 μm/s, which is towards the limit for bottom-up-only processing, this equates to a drilling time of 5-6 seconds per hole. When the hybrid process begins to occur, the process time ceases to be inversely proportional to the z-axis translation speed, and we observe the process time to fall in the 5-10 second range. Therefore, since there are no improvements to throughput and minimal potential reductions in hole taper, we conclude that there are no significant advantages to z-axis translation speeds at or above the level that causes the hybrid bottom-up/top-down process to occur. Holes with sidewall taper of <5 degrees can be generated with a wide range of z-axis speeds at 260 kHz (90% and 95% pulse overlap) and 521 kHz (95% pulse overlap).

In many applications, a straightforward way to increase throughput is to increase the repetition—rate for example doubling the repetition rate to apply double the average power is expected to increase throughput by a factor of two in many instances. These results do not follow that expectation. For example, the galvanometer movement speed for 90% pulse overlap at 260 kHz is identical to that for 95% pulse overlap at 521 kHz, but the potential throughput only increases a small amount, as described in the previous paragraph, due to a shift in the process window for bottom-up ablation due to enhancements of thermal accumulation and incubation effects.

In summary, holes with sidewall taper <5° can be generated with a wide range of z-axis speeds at 260 kHz (90% and 95% pulse overlap) and 521 kHz (95% pulse overlap). The fastest process, near the transition from a bottom-up process to a hybrid process, generates holes with 4-5° taper in 5-6 seconds. If lower taper is desired, it can be achieved at the expense of throughput, with average taper values observed below 2° near 20 μm/s at 521 kHz.

### Avoiding Cracks and Chips

Now that we have defined conditions for generating low taper holes in sapphire with acceptable throughput, we must consider the quality of the holes beyond taper: what conditions are necessary to avoid cracking and chipping during processing, and how does this affect the process window that was determined while only considering taper and throughput?

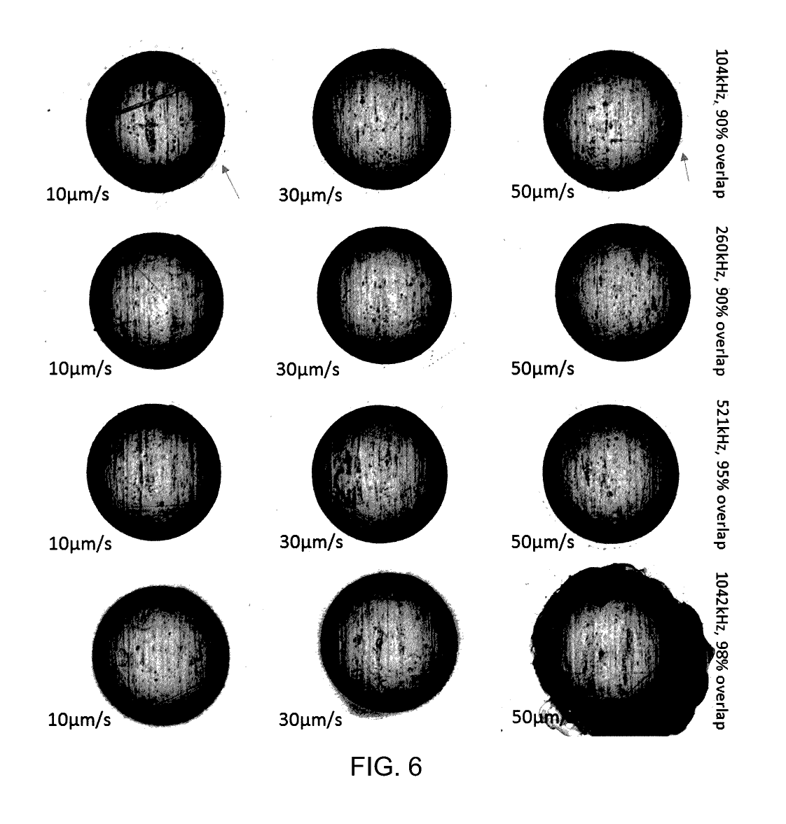

We present representative pictures of hole quality at different z-axis speeds and repetition rates in FIG. 6. At each repetition rate, the pulse overlap was chosen that demonstrated the best hole quality and least amount of cracking. The circularity and symmetry of all holes is excellent and is consistent across the entire parameter space that was tested. In the top row, holes generated at 104 kHz and 90% pulse overlap are shown. At 10 μm/s, the hole shows large taper (7°, as per FIG. 3) and cracking. Holes drilled at 30 μm/s and 50 μm/s each have less taper, though the hole at 50 μm/s is cracked. The holes at 260 kHz (90% pulse overlap) and 521 kHz (95% pulse overlap) in the second and third rows of FIG. 6 progress similarly both increase slightly in taper from 10 μm/s to 50 μm/s (from ˜2° to ˜4°), and no holes in this z-axis speed range are cracked. Holes at 1042 kHz (bottom row) proceed similarly to those at 260 kHz and 521 kHz in terms of taper, but the quality is clearly decreased—very severe damage is evident at 50 μm/s, and sticky particulates are visible at 10 μm/s and 30 μm/s. Similar particulates were easily removed from holes generated at lower repetition rates with a gentle alcohol swab, but remained partially on the surface at 1042 kHz. This reflects increased thermal effects while processing at high pulse overlap and high repetition rate.

In FIG. 7 we present a plot of hole quality vs. taper, where we assign a value of “1” to holes with no cracking and (at the most) very minor chipping, and a value of “0” to holes with visible cracks and/or chips. Results from all holes generated at repetition rates of 104 kHz, 260 kHz, 521 kHz, and 1042 kHz are compiled in this plot. We observe a clear demarcation in the likelihood of hole cracking for taper values below and above 5°. For holes with taper of ≦5°, we found no chipping or cracking 86% of the time. For holes with taper >5°, however, no chipping or cracking was only observed in 24% of cases. This demonstrates a strong correlation between hole quality and taper. Overall, this agrees well with the process window defined in the previous section—holes drilled in sapphire with low taper (≦5°) are unlikely crack or exhibit large chipping. With the large parameter space explored in these experiments, parameters for individual holes were not generally tested more than once or twice, which could easily result in false negatives or positives in terms of hole cracking. FIG. 7 suggests that working with parameters that generate holes with lower than 5° taper ensures a high likelihood of successful drilling. The best conditions for avoiding cracks are therefore 260 kHz at 90% and 95% pulse overlap, and 521 kHz at 95% pulse overlap. Tapers for all three of these sets of conditions remain below 5° at z-axis movement speeds through the transition from bottom-up ablation to the hybrid process.

In addition to cracking and chipping, we must also consider the conditions that result in the formation of back-side damage rings during processing. The magnitude of these damage rings can vary strongly, as shown in FIG. 8. Here, we present examples of a damage ring that has just barely started to form (left panel) and could easily be missed if one were not specifically looking for it, along with much more obvious damage rings (center and right panels). When these damage rings are most strongly apparent, they can also affect the edge quality of the hole at the bottom surface, as in the rightmost example. In brief, trends for the appearance of these rings are not as clear as those for cracks and chips. As with cracking, the presence of damage rings is strongly linked to large taper angles, and the acceptable process parameter space is comprised of 260 kHz at 90% and 95% pulse overlap, and 521 kHz at 95% pulse overlap.

### CONCLUSIONS

In contrast to earlier trials with a 50 ps laser source and similar specs, we accomplished promising sapphire drilling results with a fiber laser system of pulse duration in a range of less than 2 ps (e.g., less than or equal to 1 ps, less than or equal to 0.8 ps, etc.). The process initialization due to nonlinear absorption and the control of the dynamic interplay of energy deposition, material ejection and heat dissipation in the substrate define a process window at fairly high repetition rates (typically 500 kHz) and high pulse pulse overlap (90-98%) to maintain the bottom up process for the most part of the drilling process. Under these conditions drilling of 400 μm holes in 430 μm substrates could be obtained within less than 5 s with a taper angle below 2°.

At a certain point during the drilling procedure the lifting of the focus position surpasses the threshold of surface absorption. This is the transition point when the bottom up process switches to the typical top down ablation mechanism which is affected by taper and poor backside quality. Therefore the general finding within this study is that process speed and quality both benefit from the bottom up process. The earlier the process switches to the top down ablation the more pronounced are taper angle and back-side damage.

Although not illustrated, it will be appreciated that operations of the laser source, the beam positioning system, the Z-axis translation system, etc., may be controlled via one or more controllers communicatively coupled thereto. A controller can be provided as a programmable processor (e.g., including one or more general purpose computer processors, microprocessors, digital signal processors, or the like or any combination thereof) configured to execute instructions. These instructions may be implemented software, firmware, etc., or in any suitable form of circuitry including programmable logic devices (PLDs), field-programmable gate arrays (FPGAs), field-programmable object arrays (FPGAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof. Software instructions for implementing the detailed functionality can be readily authored by artisans, from the descriptions provided herein, e.g., written in C, C++, Visual Basic, Java, Python, Tel, Perl, Scheme, Ruby, etc. Software instructions are commonly stored as instructions in one or more data structures conveyed by tangible media, such as magnetic or optical discs, memory cards, ROM, etc., which may be accessed locally, remotely (e.g., across a network), or a combination thereof.

Having described and illustrated various embodiments of the present invention, it will be recognized that the technology is not so limited, and that one or more of the aforementioned process parameters may be adjusted, depending on such factors as the thickness of the sapphire to be drilled, the desired diameter of the hole to be drilled, the desired throughput of the hole drilling process, the desired quality of the resultant holes, the desired taper of the drilled hole, the particular chemical or material characteristics of the material being drilled, or the like or any combination thereof. One of ordinary skill in the art will nevertheless appreciate that, if one or more processing parameters are changed, one or more other processing parameters should be adjusted accordingly. Thus, the laser source can generate laser pulses having a pulse duration that is 50 ps or less (e.g., 40 ps or less, 30 ps or less, 20 ps or less, 10 ps or less, 5 ps or less, 2 ps or less, 1 ps or less, 0.8 ps or less, etc.). Moreover, the laser pulses can be generated as IR, green or UV laser pulses. For example, the laser pulses can have a wavelength of 1030 nm (or thereabout), 515 nm (or thereabout), 343 nm (or thereabout), etc. Laser pulses can be output at a repetition rate in a range from 20 kHz to 3 MHz (e.g., 50 kHz to 1 MHz or thereabout, 100 kHz to 500 kHz or thereabout, 100 kHz to 250 kHz or thereabout, etc.). Of course, the repetition rate can be greater than 3 MHz or less than 20 kKz. In some embodiments, the pulse overlap can be in a range from 50% to just less than 100% (e.g., in a range from 70% to 98%, in a range from 80% to 95%, in a range from 95% to 98%, etc.). In some embodiments, the pulse overlap can be less than 50%, depending upon the material being processed. For example, when forming holes in glass, the pulse overlap can be less than 50% (e.g., 40% or less, 30% or less, 20% or less, 10% or less, 5% or less, 1% or less, etc.) whereas, when forming holes in sapphire, the pulse overlap will typically be selected to be greater than or equal to 50%. The z-axis translation speed can be in a range from 10 μm/s to 100 μm/s (e.g., from 30 μm/s to 80 μm/s, from 50 μm/s to 60 μm/s, etc.). Of course, the z-axis translation rate can be greater than 100 μm/s or less than 10 μm/s. The aforementioned process parameters can be suitably selected to drill holes the sapphire substrate having a diameter in a range from 50 μm to 5 mm (e.g., in a range from 100 μm to 2 mm, in a range from 300 μm to 450 μm, 400 μm, etc.). Although the hole drilling techniques described herein have been discussed in connection with drilling holes, such as through holes and blind holes, in sapphire, it will be appreciated that these techniques may also be applied to forming features other than holes in sapphire, and may also be applied to form holes (or any other feature) in a material that is at least partially transparent to the wavelength of laser pulses generated by the laser source (e.g., a glass such as fused quartz, soda-lime glass, sodium borosilicate glass, alkaline earth aluminosilicate glass, alkali aluminosilicate glass, oxide glass, or the like or any combination thereof).

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive. It will be obvious to those having skill in the art that many changes may be made to the details of the above-described embodiments without departing from the underlying principles of the invention. The scope of the present invention should, therefore, be determined by the following claims, with equivalents of the claims to be included therein.

1. A method of forming a feature in a substrate, comprising:
irradiating a substrate with a beam of laser pulses, wherein the laser pulses have a wavelength selected such that the beam of laser pulses is transmitted into an interior of the substrate through a first surface of the substrate;
focusing the beam of laser pulses to form a beam waist at or near a second surface of the substrate, wherein the second surface is spaced apart from the first surface along a z-axis direction; and
translating the beam waist in a spiral pattern extending from the second surface of the substrate toward the first surface of the substrate to ablate the substrate,
wherein the beam of laser pulses is characterized, at least partly, by a pulse repetition rate, a pulse duration, a pulse overlap, and a z-axis translation speed,
wherein the pulse repetition rate is in a range from 20 kHz to 3 MHz.

2. The method of claim 1, wherein the pulse repetition rate is in a range from 100 kHz to 600 kHz.

3. The method of claim 1, wherein the pulse duration is less than or equal to 50 ps.

4. The method of claim 3, wherein the pulse duration is less than or equal to 20 ps.

5. The method of claim 4, wherein the pulse duration is less than or equal to 10 ps.

6. The method of claim 5, wherein the pulse duration is less than or equal to 1 ps.

7. The method of claim 1, wherein the pulse overlap is at least 50%.

8. The method of claim 7, wherein the pulse overlap is at least 80%.

9. The method of claim 8, wherein the pulse overlap is at least 90%.

10. The method of claim 9, wherein the pulse overlap is in a range from 95% to 98%.

11. The method of claim 1, wherein the pulse overlap is less than 50%.

12. The method of claim 1, wherein the z-axis translation speed is in a range from 10 μm/s to 100 μm/s.

13. The method of claim 12, wherein the z-axis translation speed is in a range from 30 μm/s to 80 μm/s.

14. The method of claim 13, wherein the z-axis translation speed is in a range from 50 μm/s to 60 μm/s.

15. The method of claim 1, wherein the feature is a hole.

16. The method of claim 15, wherein the hole is a through hole.

17. The method of claim 16, wherein a diameter of the hole is in a range from 50 μm to 5 mm.

18. The method of claim 1, wherein the substrate includes sapphire.

19. The method of claim 1, wherein the substrate includes glass.

20. An article, comprising: a substrate having a hole formed according to the process of claim 1.

21. An apparatus for forming a feature in a substrate, comprising:
a laser source configured to generate a beam of laser pulses;
a beam steering system configured to scan the beam of laser pulses along X- and Y-axis directions;
a z-axis translation system configured to translate a beam waist generated upon focusing the beam of laser pulses along a Z-axis direction; and
a controller coupled to at least one selected from the group consisting of the laser source, the beam steering system and the z-axis translation system, wherein the controller is operative to control at least one selected from the group consisting of the laser source, the beam steering system and the z-axis translation system, to perform the process of claim 1.
